(19) United States
(12) Patent Application Publication
(10) Pub. No.: US 2016/0341885 A1
(43) Pub. Date: Nov. 24, 2016

(54) Backlight module and a liquid crystal display using the same

(71) Applicant: SHENZHEN CHINA STAR OPTOELECTRONICS TECHNOLOGY CO.,LTD., Shenzhen, Guangdong (CN)

(72) Inventors: Chen XIE, Shenzhen, Guangdong (CN); Zhongjie LIU, Shenzhen, Guangdong (CN)

(73) Assignee: Shenzhen China Star Optoelectronics Technology Co., Ltd., Shenzhen, Guangdong (CN)

(21) Appl. No.: 14/423,102

(22) PCT Filed: Jan. 14, 2015
(86) PCT No.: PCT/CN2015/070694

§ 371 Date: Feb. 20, 2015

(30) Foreign Application Priority Data
Dec. 31, 2014 (CN) 201410854692.6

(51) Int. Cl. F21V 8/00; G02F 1/1368; G02F 1/1335

(52) U.S. Cl. CPC G02B 6/0088; G02F 1/133514; G02F 1/1368; G02B 6/0055; G02B 6/005; G02F 2202/28

(57) ABSTRACT

The present invention discloses a backlight module, comprising: a light guide plate, a glue frame, and a reflective film, the light guide plate comprises a side face and a bottom face, a bottom of the glue frame faces toward the side face and extends to match between the side face and the bottom face, the reflective film is disposed under the light guide plate and the glue frame, and the reflective film is adhered to a bottom surface of the glue frame. The present invention further discloses a Liquid Crystal Display with the backlight module. In the present invention, an area of the bottom surface of the glue frame can be enlarged by extending the bottom of the glue frame toward the side face of the light guide plate, and then have an adhered area between the reflective film and the bottom surface of the glue frame to further improve the adhered fastening degree and increase reliabilities.

### FIELD OF THE INVENTION

The present invention related to a Liquid Crystal Display technology field, and in particular, to a backlight module and a liquid crystal display using the same to achieve bezel slimming and simultaneously strengthen a fastening of a reflective film.

### BACKGROUND OF THE INVENTION

A demand of tablet displays is growing fastly to human beings with a development of information society. Liquid Crystal Display (referred to as LCD) has features of small volume, low energy-consumption, radiation-free, and occupies the leading role on the present market of panel displays.

In recent years, bezel slimming is becoming the main-streamed developing direction of LCD with increasing demanding on visual enjoyment. In order to achieve bezel slimming of LCD, distances between side walls of a light guide plate and optical films and a visual region of LCD is decreased hugely, and widths of side walls of a glue frame is decreased largely as well. However, because self-sizes of the glue frame, a double-sided tape and a reflective film has inaccuracies at manufacturing, in this situation, after the widths of the glue frame is decreased largely, an adhered area of a reflective film cannot be insured, an adhered fastening degree is decreasing largely, assembly obstacles of LCD is increasing and quality rates on manufacturing is not facilitated.

### SUMMARY

To solve problems existing in present technologies as above, an objective of the present invention is to provide a backlight module, comprising a light guide plate, a glue frame, and a reflective film; the light guide plate comprises a side face and a bottom face, a bottom of the glue frame faces toward the side face and extends to match between the side face and the bottom face, the reflective film is disposed under the light guide plate and the glue frame, and the reflective film is adhered to a bottom surface of the glue frame.

Further, a receiving groove is formed between the side face and the bottom face, the bottom of the glue frame extends an extension portion toward the side face, and the extension portion is received correspondingly within the receiving groove.

Further, an inclined surface is disposed between the side face and the bottom face, a slanting surface is disposed between an inner side face and the bottom surface of the glue frame, and the slanting surface and the inclined surface are matching correspondingly.

Further, an included angle between the inclined surface and the side face is an obtuse angle, and an included angle between the inclined surface and the bottom face is an obtuse angle.

Further, a first arc is disposed between the side face and the bottom face, a second arc is disposed between an inner side face and the bottom surface of the glue frame, and the first arc and the second arc are matching correspondingly.

Further, the first arc is convex toward the inner side face of the glue frame, and the second arc is convex toward an outer side face of the glue frame.

Further, the reflective film is adhered to the bottom surface of the glue frame by a double-sided tape.

Further, the backlight module further comprises: a light shielding portion and several optical films, the several optical films are disposed on the light guide plate, and the light shielding portion is disposed on the several optical films and the glue frame.

Further, the light shielding portion is a light shielding tape.

Another objective of the present invention is to provide a liquid crystal display, comprising the aforementioned backlight.

In the present invention, an area of the bottom surface of the glue frame can be enlarged by extending the bottom of the glue frame toward the side face of the light guide plate, and then have an adhered area between the reflective film and the bottom surface of the glue frame to further improve the adhered fastening degree and increase reliabilities.

### BRIEF DESCRIPTION OF THE DRAWING

Other aspects, features and advantages of embodiments of the present invention will be even more apparent from the following detailed description taken in connection to the accompanying drawings. In the drawings:

FIG. 1 is a structural schematic view of a liquid crystal device according to the present invention;

FIG. 2 is a partial structural schematic view of a backlight module according to a first embodiment of the present invention;

FIG. 3 is a partial structural schematic view of a backlight module according to a second embodiment of the present invention;

FIG. 4 is a partial structural schematic view of a backlight module according to a third embodiment of the present invention.

### DETAILED DESCRIPTION OF THE EMBODIMENTS

Hereinafter, detailed descriptions will be set forth for embodiments of the invention in conjunction with the accompanying drawings. However, there are many different ways to practice the present invention, and the present invention should not be explained to limit the described embodiment hereinafter. On the contrary, these provided embodiments are for explain principles and the pratical applications of the present invention for those skilled in the art understanding varius embodiments of the present invention and various modifications of properly specifica expectation.

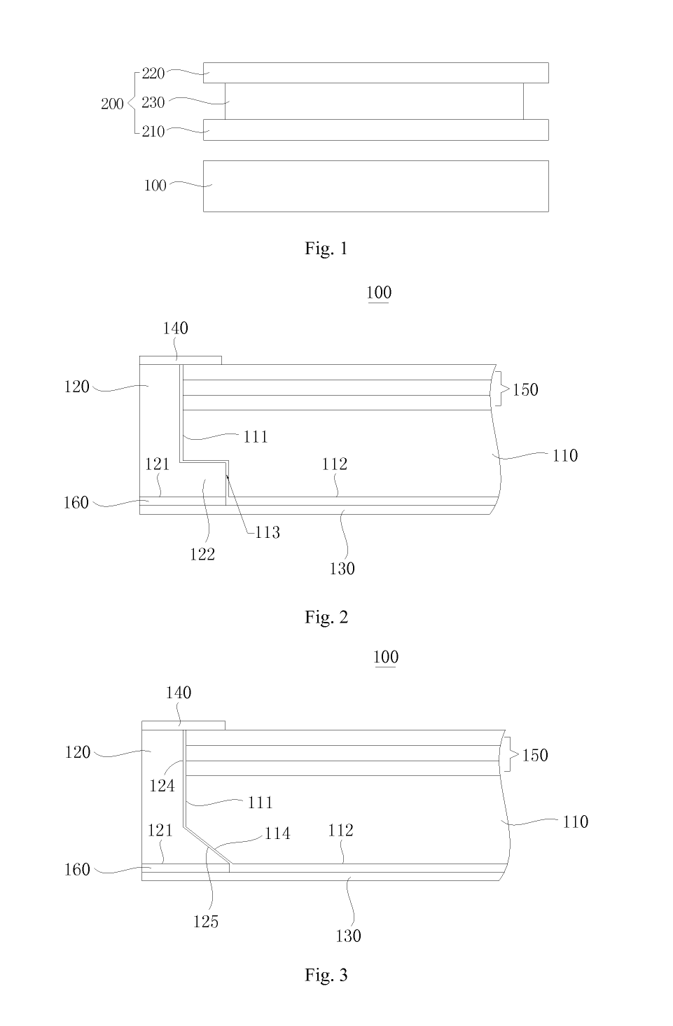

FIG. 1 is a structural schematic view of a liquid crystal device according to the present invention.

Refer to FIG. 1, a liquid crystal device according to the present invention comprises a liquid crystal display panel 200 and a backlight module 100 correspondingly disposed to the liquid crystal display panel 200, wherein, the backlight module 100 provides displaying light source to the liquid crystal display panel 200 to display images for the liquid crystal display panel 200.

The liquid crystal display panel 200 usually comprises a Thin Film Transistor (referred to as TFT) array substrate 210, a color filter (referred to as CF) substrate 220 and a liquid crystal layer 230 pressed between the TFT array substrate 210 and the CF substrate 220, wherein, the liquid crystal layer 230 comprises several liquid crystal molecules. Because particular structures of the liquid crystal display panel 200 of the present invention and particular structures of a liquid crystal display panel in the art are basically the same, thus no detailed description here.

Detail descriptions are processing to the particular structures of the backlight module 100 according to the present invention by utilizing multiple embodiments hereinafter.

### The First Embodiment

FIG. 2 is a partial structural schematic view of a backlight module according to a first embodiment of the present invention.

Refer to FIG. 2, a backlight module 100 according to the first embodiment of the present invention comprises: a light guide plate 110, a glue frame 120, a reflective film 130, a light shielding portion 140 and several optical films 150.

Specifically speaking, the light guide plate 110 comprises a side face 111 and a bottom face 112 vertical to the side face 111. A bottom of the glue frame 120 extends toward the side face 111 to match between the side face 111 and the bottom face 112 to expand a bottom surface 121 of the glue frame 120 to enlarge its area. The reflective film 130 is disposed under the light guide plate 110 and the glue frame 120, and the reflective film 130 is adhered to the bottom surface 121 of the glue frame 120.

As aforementioned description, the area of the bottom surface 121 of the glue frame 120 is enlarged by extending the bottom of the glue frame 120 toward the side face 111 of the light guide plate 110 to further enlarge an adhered area between the reflective film 130 and the bottom surface 121 of the glue frame 120, and then further improve adhered fastening degree of the reflective film 130 and increase reliabilities.

Further, a receiving groove 113 is formed between the side face 111 and the bottom face 112, the bottom of the glue frame 120 extends an extension portion 122 toward the side face 111, and the extension portion 122 is matched with the receiving groove 113; therefore, the extension portion 122 is received correspondingly within the receiving groove 113 to extend the bottom surface 121 toward a direction of the side face 111 and further enlarge an area of the bottom surface 121.

Further, according to the first embodiment of the present invention, particularly, the reflective film 130 is adhered to the bottom surface 121 of the glue frame 120 by a double-sided tape 160, and the reflective film is used to reflect light emitted from the bottom face 112 of the light guide plate 110 back to the light guide plate 110. The present invention is limited in using the double-sided tape 160, but can be other adhered methods of suitable types to adhere the reflective film 130 to the bottom surface 121 of the glue frame 120.

Otherwise, several optical films 150 are disposed on the light guide plate 110 to collect light emitted from the light guide plate 110 and then to increase brightness of light emitted from the light guide plate 110 and then further increase upward brightness of light emitted from the light guide plate 110; furthermore, light emitted from the light guide plate 110 can be softened and then an even surface light source can be provided to the liquid crystal display panel 200. The light shielding portion 140 is disposed on the several optical films 150 and the glue frame 120 to shield light leaking from gaps between the light guide plate 110 and the glue frame 120. According to the first embodiment of the present invention, preferably, the light shielding portion 140 is a light shielding tape, but the present invention is not limited hereto.

What is needed to describe is: the backlight module 100 according to the first embodiment of the present invention further comprises other optical components of suitable types which can referred to the contents in the present technologies and not be detailedly descripted hereto.

### The Second Embodiment

FIG. 3 is a partial structural schematic view of a backlight module according to a second embodiment of the present invention.

Refer to FIG. 3, a backlight module 100 according to the second embodiment of the present invention comprises: a light guide plate 110, a glue frame 120, a reflective film 130, a light shielding portion 140 and several optical films 150.

Specifically speaking, the light guide plate 110 comprises a side face 111 and a bottom face 112 vertical to the side face 111. A bottom of the glue frame 120 extends toward the side face 111 to match between the side face 111 and the bottom face 112 to expand a bottom surface 121 of the glue frame 120 to enlarge its area. The reflective film 130 is disposed under the light guide plate 110 and the glue frame 120, and the reflective film 130 is adhered to the bottom surface 121 of the glue frame 120.

As aforementioned description, the area of the bottom surface 121 of the glue frame 120 is enlarged by extending the bottom of the glue frame 120 toward the side face 111 of the light guide plate 110 to further enlarge an adhered area between the reflective film 130 and the bottom surface 121 of the glue frame 120, and then further improve adhered fastening degree of the reflective film 130 and increase reliabilities.

Further, an inclined surface 114 is disposed between the side face 111 and the bottom face 112, a slanting surface 125 is disposed between an inner side face 124 and the bottom surface 121 of the glue frame 120, and the slanting surface 125 and the inclined surface 114 are matching correspondingly to extend the bottom surface 121 toward the direction of the side face 111 and then enlarge an area of the bottom surface 121. Furthermore, an included angle between the inclined surface 114 and the side face 111 is an obtuse angle, and an included angle between the inclined surface 114 and the bottom face 112 is an obtuse angle; in order to match correspondingly with the inclined surface 114, an included angle between the slanting surface 125 and the inner side face 124 is an obtuse angle, an included angle between the slanting surface 125 and the bottom face 112 is an obtuse angle, but the present invention is not limited hereto.

Further, according to the second embodiment of the present invention, particularly, the reflective film 130 is adhered to the bottom surface 121 of the glue frame 120 by a double-sided tape 160, and the reflective film is used to reflect light emitted from the bottom face 112 of the light guide plate 110 back to the light guide plate 110. The present invention is limited in using the double-sided tape 160, but can be other adhered methods of suitable types to adhere the reflective film 130 to the bottom surface 121 of the glue frame 120.

Otherwise, several optical films 150 are disposed on the light guide plate 110 to collect light emitted from the light guide plate 110 and then to increase brightness of light emitted from the light guide plate 110 and then further increase upward brightness of light emitted from the light guide plate 110; furthermore, light emitted from the light guide plate 110 can be softened and then an even surface light source can be provided to the liquid crystal display panel 200. The light shielding portion 140 is disposed on the several optical films 150 and the glue frame 120 to shield light leaking from gaps between the light guide plate 110 and the glue frame 120. According to the second embodiment of the present invention, preferably, the light shielding portion 140 is a light shielding tape, but the present invention is not limited hereto.

What is needed to describe is: the backlight module 100 according to the second embodiment of the present invention further comprises other optical components of suitable types which can referred to the contents in the present technologies and not be detailedly descripted hereto.

### The Third Embodiment

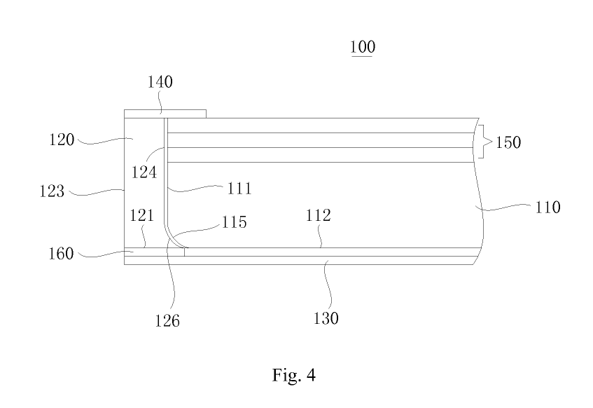

FIG. 4 is a partial structural schematic view of a backlight module according to a third embodiment of the present invention.

Refer to FIG. 4, a backlight module 100 according to the third embodiment of the present invention comprises: a light guide plate 110, a glue frame 120, a reflective film 130, a light shielding portion 140 and several optical films 150.

Specifically speaking, the light guide plate 110 comprises a side face 111 and a bottom face 112 vertical to the side face 111. A bottom of the glue frame 120 extends toward the side face 111 to match between the side face 111 and the bottom face 112 to expand a bottom surface 121 of the glue frame 120 to enlarge its area. The reflective film 130 is disposed under the light guide plate 110 and the glue frame 120, and the reflective film 130 is adhered to the bottom surface 121 of the glue frame 120.

As aforementioned description, the area of the bottom surface 121 of the glue frame 120 is enlarged by extending the bottom of the glue frame 120 toward the side face 111 of the light guide plate 110 to further enlarge an adhered area between the reflective film 130 and the bottom surface 121 of the glue frame 120, and then further improve adhered fastening degree of the reflective film 130 and increase reliabilities.

Further, a first arc 115 is disposed between the side face 111 and the bottom face 112, a second arc 126 is disposed between a inner side face 124 and the bottom surface 121 of the glue frame 120, and the first arc 115 and the second arc 126 are matching correspondingly to extend the bottom surface 121 toward a direction of the side face 111 and further enlarge an area of the bottom surface 121. Otherwise, the first arc 115 is convex toward the inner side face 124 of the glue frame 120, and the second arc 126 is convex toward an outer side face 123 of the glue frame 120.

Further, according to the third embodiment of the present invention, particularly, the reflective film 130 is adhered to the bottom surface 121 of the glue frame 120 by a double-sided tape 160, and the reflective film is used to reflect light emitted from the bottom face 112 of the light guide plate 110 back to the light guide plate 110. The present invention is limited in using the double-sided tape 160, but can be other adhered methods of suitable types to adhere the reflective film 130 to the bottom surface 121 of the glue frame 120.

Otherwise, several optical films 150 are disposed on the light guide plate 110 to collect light emitted from the light guide plate 110 and then to increase brightness of light emitted from the light guide plate 110 and then further increase upward brightness of light emitted from the light guide plate 110; furthermore, light emitted from the light guide plate 110 can be softened and then an even surface light source can be provided to the liquid crystal display panel 200. The light shielding portion 140 is disposed on the several optical films 150 and the glue frame 120 to shield light leaking from gaps between the light guide plate 110 and the glue frame 120. According to the third embodiment of the present invention, preferably, the light shielding portion 140 is a light shielding tape, but the present invention is not limited hereto.

What is needed to describe is: the backlight module 100 according to the third embodiment of the present invention further comprises other optical components of suitable types which can referred to the contents in the present technologies and not be detailedly described hereto.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A backlight module, wherein, comprising a light guide plate, a glue frame, and a reflective film, the light guide plate comprises a side face and a bottom face, a bottom of the glue frame faces toward the side face and extends to match between the side face and the bottom face, the reflective film is disposed under the light guide plate and the glue frame, and the reflective film is adhered to a bottom surface of the glue frame.

2. The backlight module of claim 1, wherein, a receiving groove is formed between the side face and the bottom face, the bottom of the glue frame extends an extension portion toward the side face, and the extension portion is received correspondingly within the receiving groove.

3. The backlight module of claim 1, wherein, an inclined surface is disposed between the side face and the bottom face, a slanting surface is disposed between an inner side face and the bottom surface of the glue frame, and the slanting surface and the inclined surface are matching correspondingly.

4. The backlight module of claim 3, wherein, an included angle between the inclined surface and the side face is an obtuse angle, and an included angle between the inclined surface and the bottom face is an obtuse angle.

5. The backlight module of claim 1, wherein, a first arc is disposed between the side face and the bottom face, a second arc is disposed between a inner side face and the bottom surface of the glue frame, and the first arc and the sec and arc are matching correspondingly.

6. The backlight module of claim 5, wherein, the first arc is convex toward the inner side face of the glue frame, and the second arc is convex toward an outer side face of the glue frame.

7. The backlight module of claim 1, wherein, the reflective film is adhered to the bottom surface of the glue frame by a double-sided tape.

8. The backlight module of claim 1, wherein, the backlight module further comprises: a light shielding portion and several optical films, the several optical films are disposed on the light guide plate, and the light shielding portion is disposed on the several optical films and the glue frame.

9. The backlight module of claim 8, wherein, the light shielding portion is a light shielding tape.

10. A liquid crystal display comprises a liquid crystal display panel and a backlight module disposed correspondingly to the liquid crystal display panel, wherein, the backlight module comprises, a light guide plate, a glue frame and a reflective film, the light guide plate comprises a side face and a bottom face, a bottom of the glue frame faces toward the side face and extends to match between the side face and the bottom face, the reflective film is disposed under the light guide plate and the glue frame, and the reflective film is adhered to a bottom surface of the glue frame.

11. The liquid crystal display according to claim 10, wherein, a receiving groove is formed between the side face and the bottom face, the bottom of the glue frame extends a extension portion toward the side face, and the extension portion is received correspondingly within the receiving groove.

12. The liquid crystal display according to claim 10, wherein, an inclined surface is disposed between the side face and the bottom face, a slanting surface is disposed between an inner side face and the bottom surface of the glue frame, and the slanting surface and the inclined surface are matching correspondingly.

13. The liquid crystal display according to claim 12, wherein, an included angle between the inclined surface and the side face is an obtuse angle, and an included angle between the inclined surface and the bottom face is an obtuse angle.

14. The liquid crystal display according to claim 10, wherein, a first arc is disposed between the side face and the bottom face, a second arc is disposed between a inner side face and the bottom surface of the glue frame, and the first arc and the second arc are matching correspondingly.

15. The liquid crystal display according to claim 14, wherein, the first arc is convex toward the inner side face of the glue frame, and the second arc is convex toward an outer side face of the glue frame.

16. The liquid crystal display according to claim 10, wherein, the reflective film is adhered to the bottom surface of the glue frame by a double-sided tape.

17. The liquid crystal display according to claim 10, wherein, the backlight module further comprises: a light shielding portion and several optical films, the several optical films are disposed on the light guide plate, and the light shielding portion is disposed on the several optical films and the glue frame.

18. The liquid crystal display according to claim 17, wherein, the light shielding portion is a light shielding tape.
